(19) United States
(12) Patent Application Publication
(10) Pub. No.: US 2006/0017391 A1
(43) Pub. Date: Jan. 26, 2006

(54) Power control photocoupler and electronic device in which the power control photocoupler is used

(75) Inventor: Yasushi Hasegawa, Nara (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/184,790

(22) Filed: Jul. 20, 2005

(30) Foreign Application Priority Data
Jul. 21, 2004 (JP) 2004-213142

(51) Int. Cl. H05B 37/02

(52) U.S. Cl. 315/149

(57) ABSTRACT

The present invention is provided with a light emitting diode 11 connected on a microcomputer side, an IGBT gate control portion 20 provided with a light receiving element 21 and a push-pull circuit, and a two-way switch portion 30 for controlling an alternating current. The two-way switch portion 30 is composed of a first IGBT 31 and a second IGBT 32 whose emitters are connected to each other and whose gates are connected to the output of the push-pull circuit, and a first FRD 33 and a second FRD 34 whose anodes are connected to each other. The collector of the first IGBT 31 is connected to the cathode of the first FRD 33, and the collector of the second IGBT 32 is connected to the cathode of the second FRD 34. ON/OFF control of the alternating current on the output side is controlled by connecting a signal line between the connection point of the emitters of the first IGBT 31 and the second IGBT 32, and the connection point of the anodes of the first FRD 33 and the second FRD 34.

### CROSS REFERENCE TO RELATED APPLICATIONS

This application claims priority under 35 U.S.C. § 119(a) on Patent Application No. 2004-213142 filed in Japan on Jul. 21, 2004, the entire contents of which are hereby incorporated by reference.

### BACKGROUND OF THE INVENTION

1. Field of the Invention

The present invention relates to photocouplers for controlling AC (alternating current), and to electronic devices in which such photocouplers are used.

2. Description of the Related Art

FIG. 7 is a circuit diagram showing an example of a conventional apparatus for controlling a load.

The circuit shown in FIG. 7 is an example of a conventional load control apparatus that is constituted by using an AC current power source, and a power control element. The load control apparatus will be described here using an example in which a solid-state relay is used. It should be noted that a solid-state relay means a non-contact semiconductor relay that uses a power semiconductor device such as a gate control bidirectional triode thyristor or a reverse-blocking triode thyristor, characterized in that once the relay is turned ON, the ON-state is maintained until the current flowing through the switching portion becomes 0, even if a control signal for controlling ON/OFF is not applied.

A solid-state relay 110 shown in FIG. 7 is composed of a light emitting element 111 that converts electric signals into light (principally a gallium-arsenic LED (light emitting diode) or a gallium-aluminum-arsenic LED), a light receiving element 112 that converts light into electric signals (principally a photo-gate control-type bidirectional triode thyristor that conducts electricity when light hits the gate), and a power control element 113 (principally a gate control-type bidirectional triode thyristor). The light receiving element 112 conducts current when the light emitting element 111 emits light due to a control current I flowing through the light emitting element 111 and a current control resistor 120 that is in series with the light emitting element 111; a trigger current flows through the gate of the power control element 113; and the power control element 113 fires. Thus, current flows through a load 130 and the load 130 is activated.

Since an alternating current 140 is flowing on the output side, the current soon approaches 0 A, however if there is no input signal at this time, then since the current that flows through the thyristor portion (the light receiving element 112 and the power control element 113) is 0 A, the light receiving element 112 and the power control element 113 are OFF.

The alternating current is thus turned ON and OFF by an optical input signal.

Furthermore, with advances in energy savings in all kinds of devices in recent years, attention has also turned to the electrical power that is consumed by the load, and there is increasing demand for load control of alternating current loads at low power consumption. For example, JP 2001-111398A (referred hereafter as Patent Reference 1) proposes a spike voltage suppression circuit for semiconductor two-way switches that can suppress spike voltages generated in both directions in semiconductor two-way switches, by connecting a Zener diode and a reverse series diode circuit between the gates and the collectors of the transistors of a semiconductor two-way switch in which the transistors are connected in reverse series or reverse parallel.

However, in load control with conventional solid-state relays, although the alternating current could be turned ON and OFF, the alternating current itself could not be controlled.

With the spike voltage control circuit for semiconductor two-way switches disclosed in Patent Reference 1 serving as another example of a conventional load control device, a circuit that is configured with a two-way switch is proposed. However, since delicate drive control is difficult, depending on the condition of the load, and an input signal is usually supplied from a small-signal circuit such as a microprocessor, it has been necessary to prevent malfunction due to switching noise and the like from the load by separating the direct current small-signal circuit and the alternating current large circuit. Therefore, it is necessary to insulate with light.

### SUMMARY OF THE INVENTION

The present invention has been achieved with consideration of the above-described facts, and it is an object thereof to provide delicate drive control of a load signal, a power control photocoupler that can reduce power consumption, and electronic devices in which the power control photocoupler is used.

In order to solve the above-noted problems, the power control photocoupler of the present invention is a power control photocoupler for controlling an alternating current load connected to a secondary side based on a signal from a microcomputer connected to a primary side, and is characterized by being provided with a photocoupler portion for outputting an input signal from the primary side to the secondary side, and a control portion for controlling the alternating current load based on the output from the photocoupler portion.

With such a configuration, it is possible to reduce the current consumed when controlling the alternating current output.

With such a power control photocoupler, in the present invention, the control portion may contain a two-way switch composed of a combination of an IGBT (insulated gate bipolar transistors) and a diode.

The control portion may also use an FET (field-effect transistors) instead of the IGBT.

In any configuration of the control portion described above, the drive of the load signal can be controlled more delicately.

Furthermore, the diode of the control portion may also be composed of an FRD (fast recovery diode).

A frequency modulation circuit may also be provided as the primary side pre-circuit of the photocoupler portion. In this configuration, changes to the frequency due to changes in application and load capacity can be carried out easily as desired.

The secondary side frequency signal may be fed back into the frequency modulation circuit. In this case, the power consumed by the load may be controlled more delicately.

Furthermore, an oscillating circuit may be provided in the frequency modulation circuit so as to produce a PWM (pulse width modulation) waveform based on the secondary side frequency signal that is fed back. In this configuration, the power consumed by the load can be controlled even more delicately.

With the electronic device according to the present invention, since the current consumed in the power control photocoupler can be reduced when controlling the alternating current output, as a result, it is possible to reduce the current consumed by the electronic device.

It should be noted that the power control optical element and the electronic device can be put to practical use in electronic devices such as fridges, air-conditioners and vending machines in which solenoid valves and fans are provided as the load.

### BRIEF DESCRIPTION OF DRAWINGS

FIG. 1 is a circuit diagram showing Embodiment 1 of the power control photocoupler of the present invention.

FIG. 2 is an explanatory diagram showing a current path in a two-way switching portion of an alternating current that is output from the alternating current power source of FIG. 1

FIG. 3 is an explanatory diagram showing an output current waveform of the alternating current power source of FIG. 1.

FIG. 4 is a circuit diagram showing Embodiment 2 of the power control photocoupler of the present invention.

FIG. 5 is an explanatory diagram showing an example of a current waveform used in the power control photocoupler shown in FIG. 4.

FIG. 6 is a circuit diagram showing another example of a two-way switch portion that constitutes the power control photocoupler of the present invention.

FIG. 7 is a circuit diagram showing an example of a conventional load control device.

### DESCRIPTION OF THE PREFERRED EMBODIMENTS

The embodiments of the present invention are described below with reference to the drawings.

### Embodiment 1

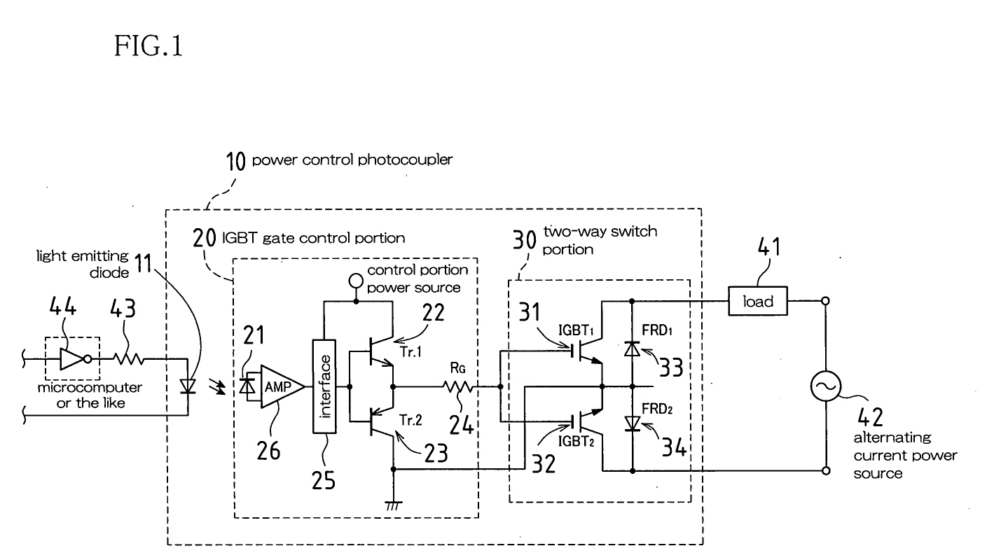

FIG. 1 is a circuit diagram showing Embodiment 1 of the power control photocoupler of the present invention.

A power control photocoupler 10 of the present invention is constituted by an photocoupler portion that is provided with a light emitting diode 11, an IGBT gate control portion 20 that is provided with a push-pull circuit, and a two-way switch circuit 30 for alternating current control.

The IGBT gate control portion 20 is constituted by a light receiving element 21 for receiving light that is output from the light emitting diode 11, an amplifier (AMP) 26 connected to the light receiving element 21, an interface 25 connected to the AMP 26, and a push-pull circuit that is connected to the interface 25. The push-pull circuit is constituted by two transistors (a first Tr 22 and a second Tr 23) and a resistor (RG 24). Furthermore, the emitter of the first Tr 22, whose collector is connected to the control power source portion, and the emitter of the second Tr 23 whose collector is connected to an earth potential, are connected, and one terminal of the RG 24 is connected to the connection point of the set of emitters. Furthermore, one terminal of the interface 25, whose other terminal is connected to the control portion power source, is connected to the bases of the first Tr22 and the second Tr 23.

The two-way switch portion 30 is constituted by two transistors (a first IGBT. 31 and a second IGBT 32) whose emitters are connected to each other, and two diodes (a first FRD 33 and a second FRD 34) whose anodes are connected to each other, wherein the other end of the RG 24 is connected to the gate terminal of the first -IGBT 31 and the second IGBT 32. The collector of the first IGBT 31 is connected to the cathode of the first FRD 33, and the collector of the second IGBT 32 is connected to the cathode of the second FRD 34. The point at which the emitters of the first IGBT 31 and the second IGBT 32 are connected is connected by a signal line to the point at which the anodes of the first FRD 33 and the second FRD 34 are connected, and the collector of the second Tr 23 of the IGBT gate control portion 20 is connected to the point at which the emitters of the first IGBT 31 and the second IGBT 32 are connected. Moreover, the load 41 and the alternating current power source 42 are connected between the connection point of the collector of the first IGBT 31 and the cathode of the first FRD 33, and the connection point of the collector of the second IGBT 32 and the cathode of the second FRD 34. That is, in the present Embodiment 1, FRDs (fast recovery diodes) that have the same voltage resistance and response speed as IGBTs are used as the two diodes in the two-way switch portion 30.

Because the circuit is configured in this way, provided that the signal received by the light emitting diode 11 is at a high level, the first Tr 22 is turned ON and the second Tr 23 is turned OFF, an electric charge is supplied to the gates of the first IGBT 31 and the second IGBT 32, and the first IGBT 31 and the second IGBT 32 both turn ON. On the other hand, if the signal input to the light emitting diode 11 is at a low level, then the first Tr 22 is turned OFF and the second Tr 23 is turned ON, supply of the electric charge to the gate of the first IGBT 31 and the gate of the second IGBT 32 stops, and the first IGBT 31 and the second IGBT 32 both turn OFF.

ON/OFF actuation of the power control photocoupler 10 will be described next with reference to the drawings.

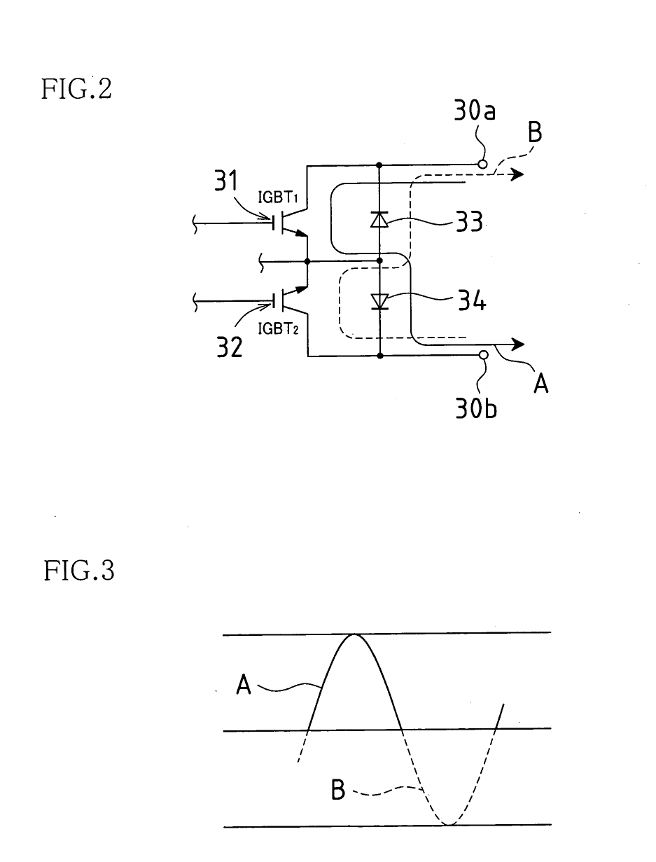

FIG. 2 is an explanatory diagram showing the current path of the alternating current that is output from the alternating current source 42 in the two-way switch portion 30, and FIG. 3 is an explanatory diagram showing an output current waveform of the alternating current source 42.

Since the alternating current source 42 is connected to the output side in the power control photocoupler 10 of the present embodiment, when the first IGBT 31 and the second IGBT 32 are both ON (that is to say, when the signal input to the light emitting diode 11 is at a high level), in the part of the output of the alternating current source 42 indicated by A in FIG. 3, a current A flows from one terminal 30a of the two-way switch portion 30, via the first IGBT 31 and the second FRD 34, to the other terminal 30b, and in the part of the output of the alternating current source 42 indicated by B in FIG. 3, a current B flows from the other terminal 30b via the second IGBT 32 and the first FRD 33 to the one terminal 30a, as shown in FIG. 2. As a result, it is possible to drive the load 41. On the other hand, when the first IGBT 31 and the second IGBT 32 are both OFF (that is to say, when the input signal to the light emitting diode is at a low level, the power control photocoupler 10 is OFF, and current does not flow to the load 41. That is to say, the alternating current can be turned ON/OFF by switching the input signal to the light emitting diode 11 between high and low. Consequently, it is possible to control the power consumed on the output side by modulating the control signal from the microcomputer 44 connected to the light emitting diode 11 via the resistor 43 into a pulse signal of a specific frequency before transmitting it to the light emitting diode 11. More specifically, the total power consumed may be decreased by repeatedly turning the output side alternating current ON/OFF by transmitting the input signal to the light emitting diode 11 at a frequency that is higher (from hundreds of hertz to a few kilohertz) than the frequency of the output side alternating current (50 Hz or 60 Hz) to switch the first IGBT 31 and the second IGBT 32 ON/OFF at high speed.

With the power control photocoupler 10 of the present Embodiment 1, since the space between input and output is electrically insulated and the signal from the microcomputer can be directly connected, the power consumption can be reliably controlled without being affected by noise caused by fluctuating electric potential, for example, on the output side. Furthermore, changes to the frequency due to changes in application and load capacity can be carried out easily as desired.

### Embodiment 2

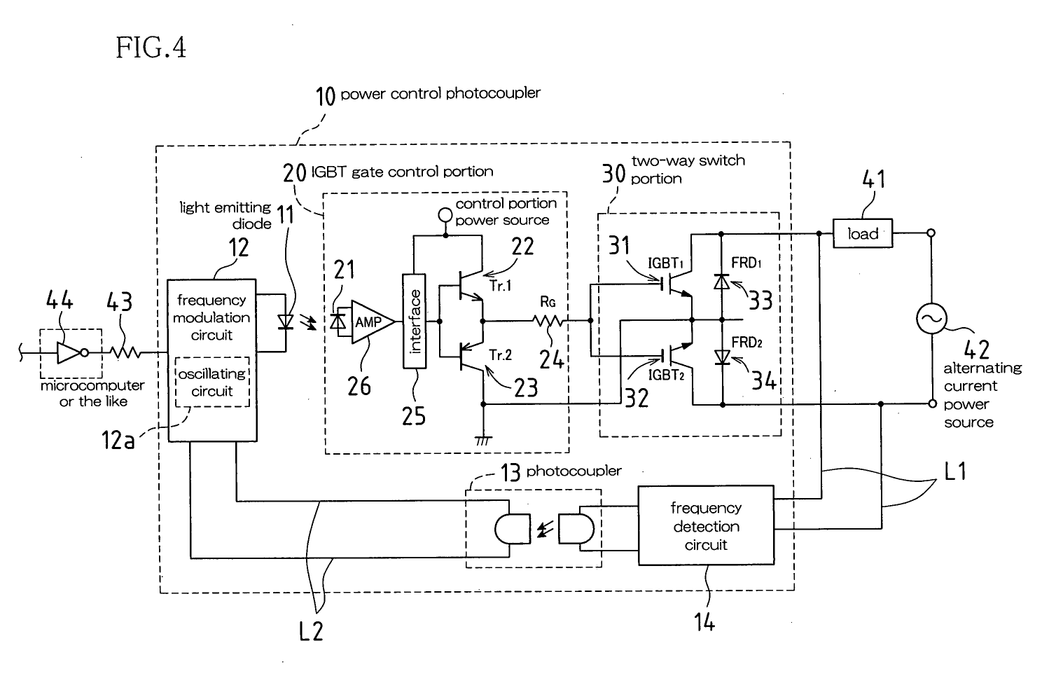

FIG. 4 is a circuit diagram showing Embodiment 2 of the power control photocoupler 10 of the present invention.

The power control photocoupler 10 of Embodiment 2 of the present invention has a further feedback portion for detecting the frequency of the output alternating current and feeding it back to the power control photocoupler, and a frequency modulation circuit for creating a pulse width modulating waveform based on the frequency that was fed back, added onto the power control photocoupler shown in the above-noted Embodiment 1.

That is to say, as well as providing a frequency modulation circuit 12 between the light emitting diode 11 and the resistor 43, a photocoupler 13 and a frequency detection circuit 14 for detecting the frequency of the alternating current are provided between a direct current line power source L2 of the frequency modulation circuit 12, and an alternating current power source line L1 connected to the two output terminals of the two-way switch portion 30. Since the alternating current power source line L1 and the direct current power source line L2 that connect the output and input sides of the power control photocoupler 10 are non-contactably connected via the photocoupler 13, the power control photocoupler 10 is less affected by noise and the like, and its operation is reliable.

With the power control photocoupler 10 of the present Embodiment 2, it is possible to create a PWM control waveform that corresponds to the frequency of the output side alternating current by modulating the output (for example, a triangular waveform or the like) from an oscillating circuit 12a provided in the frequency modulating circuit 12, based on the frequency that is fed back, and to use the waveform to control the light emitting diode 11, thus the energy consumed by the load 41 can be controlled even more delicately.

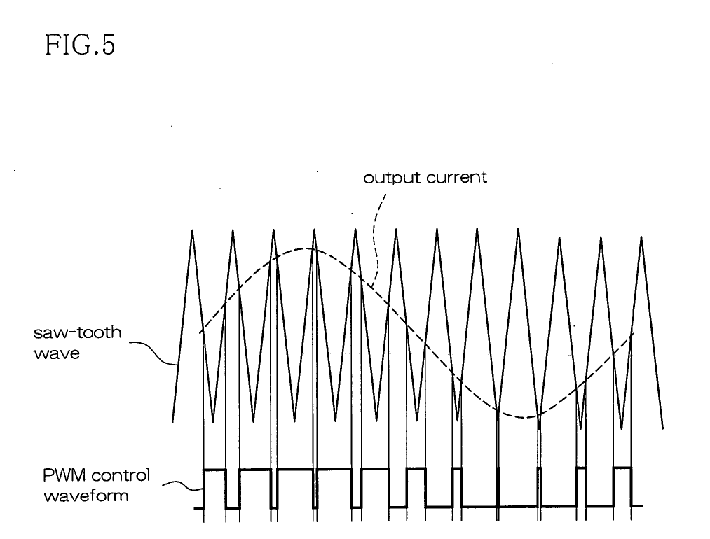

FIG. 5 is an explanatory diagram showing an example of the current waveform used in the power control photocoupler 10 shown in FIG. 4. The solid line waveform in FIG. 5 indicates a saw-tooth waveform that is output from the oscillating circuit 12a, the broken line waveform shows the current (output current) that is output from the direct current power source line L2 to the frequency modulating circuit 12, and the pulse waveform with the thick solid line shows the PWM control waveform.

Moreover, the strength of the operating load can be controlled by adjusting the frequency of the PWM control waveform and the duty ratio, and it is also possible to control the operating load by other parameters of the electronic devices provided with the load.

Another example of the two-way switch portion is described next.

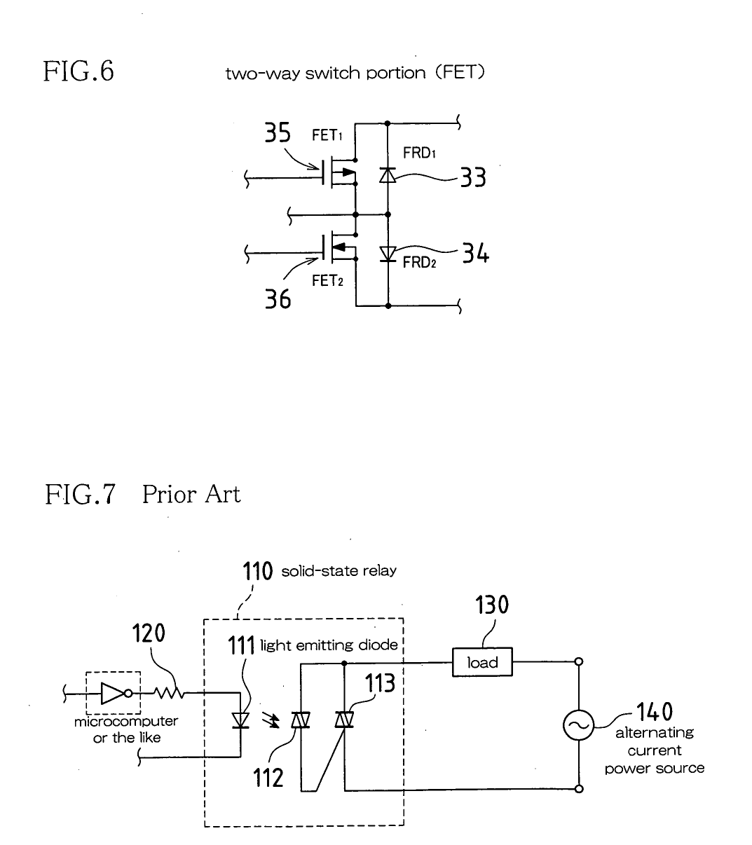

FIG. 6 is a circuit diagram showing another example of the two-way switch portion that constitutes the power control photocoupler of the present invention

The above noted Embodiment 1 and Embodiment 2 have been described in which IGBTs are treated as the transistors constituting the two-way switch portion, however, depending on the voltage and the current, the same effect may be achieved by using FETs (a first FET 35 and a second FET 36) as a substitute for the IGBTs.

It is possible to reduce the current consumed when controlling alternating current output using the power control photocoupler 10 configured above, and more delicate control is possible by providing microcomputer control.

Furthermore, by mounting the power control photocoupler 10 having the configuration described above into an electronic device, the consumed current can be reduced by the power control photocoupler when controlling the alternating current power output, and as a result, the current consumed by the electronic device can be reduced.

The present invention can be embodied and practiced in other different forms without departing from the spirit and essential characteristics thereof. Therefore, the above-described embodiments are considered in all respects as illustrative and not restrictive. The scope of the invention is indicated by the appended claims rather than by the foregoing description. All variations and modifications falling within the equivalency range of the appended claims are intended to be embraced therein.

1. A power control photocoupler for controlling an alternating current load connected to a secondary side based on a signal from a microcomputer connected to a primary side, comprising:
a photocoupler portion for outputting an input signal from the primary side to the secondary side, and
a control portion for controlling the alternating current load based on the output of the photocoupler portion.

2. The power control photocoupler according to claim 1,
wherein the control portion contains a two-way switch portion composed of a combination of an insulated gate bipolar transistor and a diode.

3. The power control photocoupler according to claim 1,
wherein the control portion contains a two-way switch portion composed of a combination of a field-effect transistor and a diode.

4. The power control photocoupler according to claim 2 or 3,
wherein the diode is a high-speed rectifier diode.

5. The power control photocoupler according to claim 1, wherein a frequency modulating circuit is provided as a pre-circuit on the primary side of the photocoupler.

6. The power control photocoupler according to claim 2, wherein a frequency modulating circuit is provided as a pre-circuit on the primary side of the photocoupler.

7. The power control photocoupler according to claim 3, wherein a frequency modulating circuit is provided as a pre-circuit on the primary side of the photocoupler.

8. The power control photocoupler according to claim 4, wherein a frequency modulating circuit is provided as a pre-circuit on the primary side of the photocoupler.

9. The power control photocoupler according to claim 5;
wherein the frequency signal on the secondary side is fed back to the frequency modulating circuit.

10. The power control photocoupler according to claim 9, further comprising:
an oscillating circuit in the frequency modulating circuit,
wherein a pulse width modulation waveform is created based on the secondary side frequency signal that was fed back.

11. An electronic device in wherein the power control photocoupler according to claim 1 is used.
